(19) United States
(12) Patent Application Publication
(10) Pub. No.: US 2005/0280781 A1
(43) Pub. Date: Dec. 22, 2005

(54) Adjoining-type architecture for the assembly of a rear projection television

(75) Inventors: Ling-Yuan Tseng, Saratoga, CA (US); Atsuo Kusada, Mahwah, NJ (US)

Correspondence Address: C.P. Chang;c/o Pacific Law Group LLP, Suite 525, 224 Airport Parkway, San Jose, CA, 95110, US

(73) Assignee: Taiwan Micro Display Corp., Chunan Miaoli (TW)

(21) Appl. No.: 10/870,076

(22) Filed: Jun. 16, 2004

(51) Int. Cl. G03B 21/22; G03B 21/28

(52) U.S. Cl. 353/74; 353/77

(57) ABSTRACT

An adjoining-type architecture and assembly method of a rear projection TV is disclosed. The TV enclosure is partitioned into interconnectable housing sections. The internal components are partitioned into interconnectable subassemblies. Each subassembly includes second adjoining devices for detachably adjoining the subassembly to corresponding housing sections. Likewise, each housing section includes first adjoining devices for detachably adjoining the housing section to corresponding subassemblies. Hence, this architecture allows low production assembly time and cost, small shipping volume, user self-assembly and self-maintenance. To effect interconnection between any two housing sections, one housing section includes third adjoining devices for mating with corresponding fourth adjoining devices provided on the other housing section. The interconnection among the subassemblies can be mechanical, electrical or an optical coupling. The subassemblies include an IO and power terminal, a control electronics module, an optical mechanism, an audio module, a reflective mirror and a projection screen.

### BACKGROUND OF THE INVENTION

1. Field of the Invention

The present invention relates generally to the field of image display devices. More particularity, the present invention is directed to an overall architecture and method for the assembly of a rear projection television (TV).

2. Description of the Related Art

Rear projection TV (also called internal projecting TV) is widely utilized for large screen display or related image reception and viewing. As the rear projection TV can significantly magnify a display image through internal image projecting optics, it can solve the problem of display size limitation of a cathode ray tube (CRT) caused by a safety imposed upper limit of its internal coil voltage. Thus, it is well known that the screen size of many rear projection TV often exceeds 50 inches to further elevate visual enjoyment for the viewer.

However, among the structures of the well known rear projection TV units in the market, whether it is a unit based upon a Digital Light Processor (DLP) technology from Texas Instruments or a unit based upon a Liquid Crystal on Silicon (LCOS) technology, the observation is that enclosed within an otherwise very bulky TV housing are a set of precision but light-weighted subassemblies like a projection screen, an optical mechanism, a control electronics module and an audio module. Therefore, in addition to an increased assembly time and cost during manufacturing, the assembled thus bulky rear projection TV units must now be very carefully handled throughout the shipping process and the installation process at the user's site such that the internal subassemblies should not be damaged or their relative alignments should not be disturbed. Thus, regardless of the careful handling, accidents can still happen and this represents a significant disadvantage during shipping and installation of the rear projection TV units.

Another disadvantage of these well known structures in the market is that, for product maintenance after installation where one or more of these subassemblies failed, the user would have to make a service call to insure that the replaced subassemblies are properly positioned and affixed to the TV unit. For example, the position and orientation of either the projection screen or the optical mechanism can affect the displayed image quality, etc. The root cause of the associated consumption of maintenance labor, time and cost mainly comes from an accompanying complex procedure for disassembly and assembly. It is therefore highly desirable to reduce or eliminate the aforementioned disadvantages.

### SUMMARY OF THE INVENTION

An adjoining-type architecture and method for the assembly of a rear projection TV is proposed according to the invention. The proposed projecting TV enclosure includes a set of interconnectable housing sections. A set of interconnectable subassemblies is also provided for the product function. Each subassembly includes a number of second adjoining devices for detachably adjoining the subassembly to a selected subset of the housing sections. Correspondingly, each housing section includes a number of first adjoining devices for detachably adjoining the housing section to a corresponding subset of the second adjoining devices of the set of interconnectable subassemblies. Hence, this architecture allows the reduction in the time and cost of projecting TV production assembly, the reduction of its shipping volume thus simplifying its shipping and allowing self-assembly by user. And, for product maintenance, the user may purchase and self-assemble only the damaged subassemblies.

To effect the interconnection between any two housing sections, a number of third adjoining devices are provided on one housing section for mating with the same number of fourth adjoining devices provided on the other housing section.

The interconnection among the set of subassemblies can be a mechanical connection, an electrical connection or an optical coupling.

An embodiment of the housing sections includes, expressed with x-y-z coordinates with the y-axis pointing to the top and the z-axis pointing to the front, a bottom housing plate lying in the x-z plane, two lateral housing plates each lying in the y-z plane, a back housing plate lying in the x-y plane, a slanted back housing plate lying in a slanted plane tilted away from the x-y plane toward the z-direction, a top housing plate lying in the x-z plane and a front housing plate lying in the x-y plane so as to leave a projection opening lying in the x-y plane and along the front face of the projecting TV.

An embodiment of the subassemblies includes a control electronics module, an optical mechanism and an audio module all located atop the bottom housing plate, a reflective mirror located beneath a bottom surface of the slanted back housing plate and a projection screen lying in the x-y plane and filling the projection opening.

To form a thinner enclosure of the rear projection TV, multiple reflective mirrors located within the TV enclosure can be employed to effect multiple folding of the video image projection light path. One specific embodiment is a two-mirror system.

The subassemblies also include an IO and power terminal, for the audio and video signal interfacing and power input to the projecting TV, located atop the bottom housing plate.

The optical mechanism includes a body having a lens head that, upon assembly of the housing sections, becomes optically essentially aligned with the reflective mirror and the projection screen such that projected video image lights from the lens head impinge upon the reflective mirror, get reflected and projected to the projection screen for proper viewing.

The effect of any residual optical misalignment can be rendered imperceptible to the user by sizing at least one of the housing sections, the optical mechanism and the reflective mirror making the projected video image 3% to 5% larger than the projection screen. To reduce the effect of any stray image resulting from the projected video image outside the projection screen, all interior surfaces of the rear projection TV not required for the video image projection can be painted black to render these surfaces essentially non-reflective.

In one embodiment, the optical alignment of the lens head is through the optical mechanism body using the combination of an indentation formed on an interior surface of the back housing plate and a locking tab that, being part of the optical mechanism body, upon being locked onto the bottom housing plate with a screw forces the optical mechanism body into a three-point contact registration with the TV enclosure.

During the assembly process, each housing section is first adjoined, through the first adjoining and the second adjoining devices, to a number of corresponding subassemblies. The set of housing sections, together with their now-adjoined set of interconnectable subassemblies, are then assembled through the third adjoining and the fourth adjoining devices to form the projecting TV.

To the accomplishment of the above and related objects, this invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawing, in which like reference characters designate the same or similar parts throughout the several views, and wherein:

FIG. 1 is an external perspective view of the rear projection TV of the present invention;

FIG. 2 is a lateral sectional view of the present invention rear projection TV illustrating the adjoining between some of its subassemblies and the TV housing;

FIG. 2A is a lateral sectional view of another embodiment of the present invention where a two-mirror system is employed to form a thinner enclosure of the rear projection TV;

FIG. 3 is another lateral sectional view of the present invention rear projection TV illustrating the adjoining between additional subassemblies and the TV housing;

FIG. 4 is a lateral sectional view of another embodiment of the present invention rear projection TV illustrating the adjoining between some of its subassemblies and the TV housing;

FIG. 5 is a top sectional view of the embodiment of FIG. 4 illustrating the adjoining between some of its subassemblies and the TV housing; and

FIG. 6 is a perspective view of a third embodiment of the present invention rear projection TV illustrating the adjoining of interconnectable housing segments to form the TV housing.

### DETAILED DESCRIPTION OF THE PREFERRED EMBODIMENTS

In the following detailed description of the present invention, numerous specific details are set forth in order to provide a thorough understanding of the present invention. However, it will become obvious to those skilled in the art that the present invention may be practiced without these specific details. In other instances, well-known methods, procedures, materials, components and circuitry have not been described in detail to avoid unnecessary obscuring aspects of the present invention. The detailed description is presented largely in terms of simplified orthogonal and perspective views. These descriptions and representations are the means used by those experienced or skilled in the art to concisely and most effectively convey the substance of their work to others skilled in the art.

Reference herein to “one embodiment” or an “embodiment” means that a particular feature, structure, or characteristics described in connection with the embodiment can be included in at least one embodiment of the invention. The appearances of the phrase “in one embodiment” in various places in the specification are not necessarily all referring to the same embodiment, nor are separate or alternative embodiments mutually exclusive of other embodiments. Further, the order of process flow representing one or more embodiments of the invention do not inherently indicate any particular order nor imply any limitations of the invention.

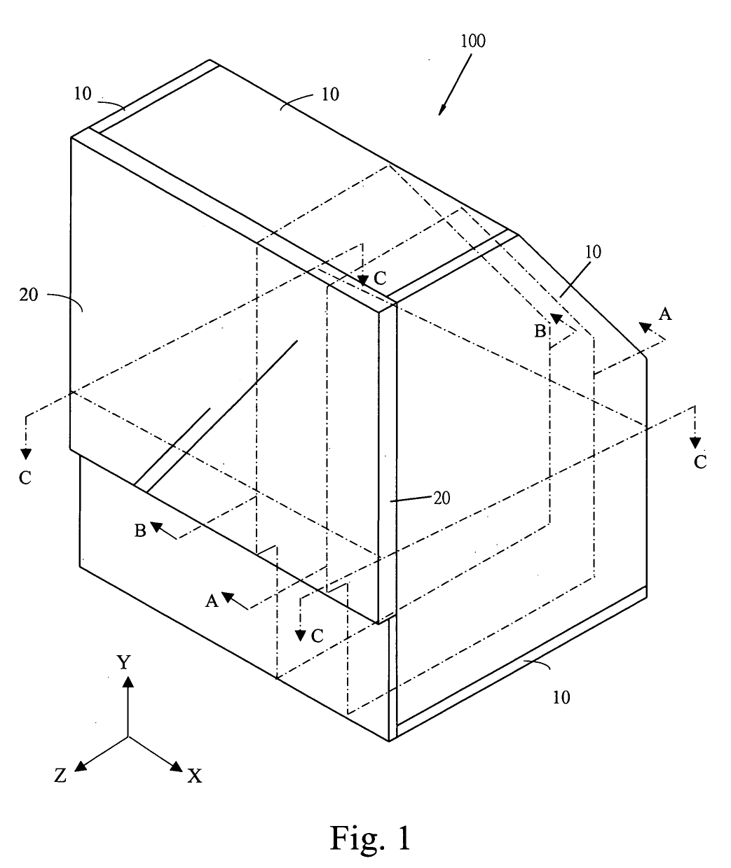

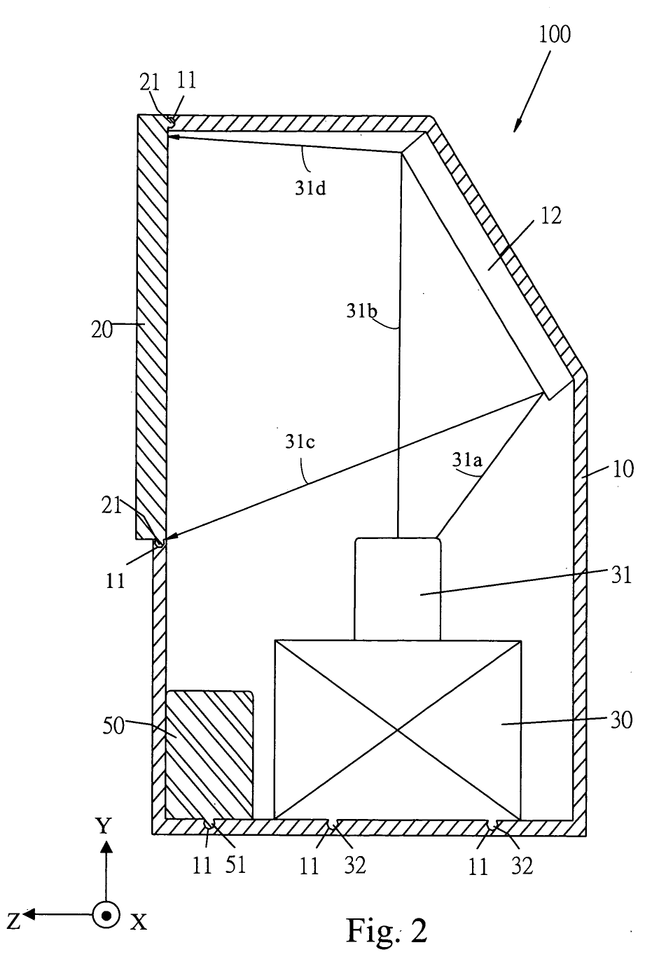

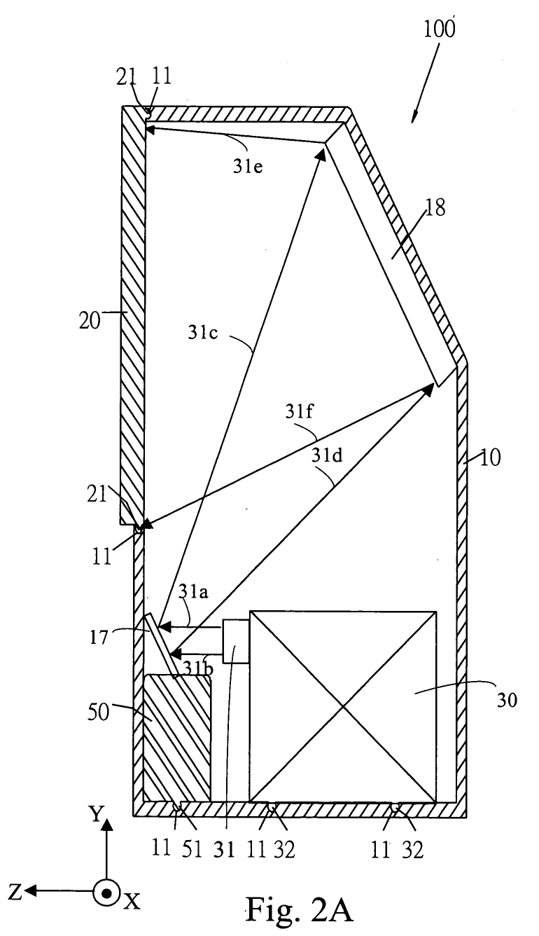

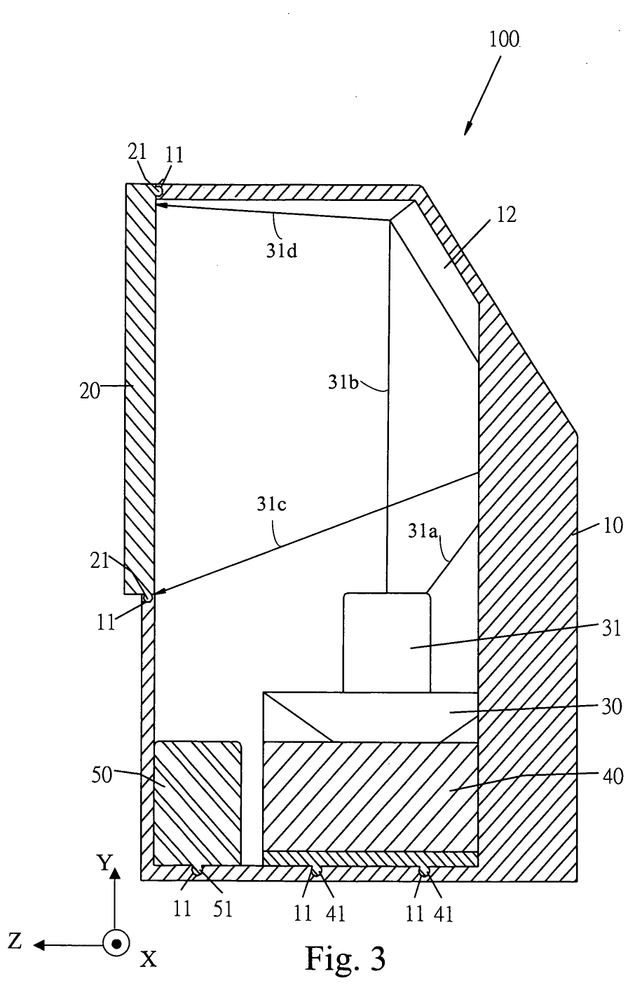

Reference is made to FIG. 1, FIG. 2 and FIG. 3. FIG. 1 is an external perspective view of the adjoining-type rear projection TV 100 of the present invention. The adjoining-type rear projection TV 100 includes a TV housing 10 on which is adjoined a projection screen 20. FIG. 2 is a lateral sectional view, along section A-A of FIG. 1, of the adjoining-type rear projection TV 100 illustrating the adjoining between some of its subassemblies and the TV housing 10. FIG. 3 is another lateral sectional view, along section B-B of FIG. 1, of the present invention rear projection TV illustrating the adjoining between additional subassemblies and the TV housing 10. Thus, the TV housing 10 includes a set of interconnected housing segments forming the enclosure of the adjoining-type rear projection TV 100. The adjoining-type rear projection TV 100 also includes a set of subassemblies providing the projecting TV function. As shown, the subassemblies include the projection screen 20, a reflective mirror 12, an optical mechanism 30, a control electronics module 40 and an audio module 50. The optical mechanism 30 further includes a lens head 31. While many electrical interconnections amongst these subassemblies will be presently described, for those skilled in the art, it should become clear that the control electronics module 40 receives externally provided electrical power and a proper video input signal, processes the video input signal, generates corresponding control and video drive signals to drive the optical mechanism 30 and also generates corresponding control and audio drive signals to drive the audio module 50 to produce an accompanying audible output for a user of the adjoining-type rear projection TV 100. Meanwhile, the optical mechanism 30 would project enlarged video images onto the projection screen 20 for viewing by the user. The image projection, as illustrated, takes place via the lens head 31 and the reflective mirror 12 signified with two source beams 31a and 31b and two corresponding reflected source beams 31c and beam 31d all contained within the TV housing 10. According to the present invention, numerous first adjoining means 11 are disposed at suitable locations along both the exterior and interior of the TV housing 10. These locations correspond to a number of pre-determined adjoining locations for each of the subassemblies like the projection screen 20, the optical mechanism 30, the control electronics module 40 and the audio module 50. An example are the two first adjoining means 11 located along the interior of the base of the TV housing 10 for adjoining the optical mechanism 30 via two second adjoining means 32 of the optical mechanism 30. Another example are the two first adjoining means 11 located along the exterior of the front (+z-direction) of the TV housing 10 for adjoining the projection screen 20 via two second adjoining means 21 of the single display face plate 20. As illustrated, the specific embodiment of the first adjoining means 11 and the second adjoining means 41 are respectively a cavity and a resilient protrusion such that, upon being pressed together, they would form a tight snap joint between a subassembly and its corresponding TV housing due to mechanical interference. Nevertheless, upon being pulled apart with an intentional and sufficiently high force later, the cavity and the resilient protrusion would still snap apart with no mechanical damage. Hence, the subassembly of projection screen 20, through its second adjoining means 21 of resilient protrusions, can be detachably adjoined to the first adjoining means 11 of cavities of the front housing segment. Secondly, the subassembly of audio module 50, through its second adjoining means 51 of resilient protrusions, can be detachably adjoined to the first adjoining means 11 of cavities of the bottom housing segment. Thirdly, the subassembly of optical mechanism 30, through its second adjoining means 32 of resilient protrusions, can be detachably adjoined to the first adjoining means 11 of cavities of the bottom housing segment, an so on. For those skilled in the art, numerous other embodiments can replace the specifically illustrated design of cavity and resilient protrusion while still accomplishing the same function of detachably adjoining the various subassemblies and their corresponding housing segments. For example, while not graphically illustrated here, the pair of second adjoining means 32 and first adjoining means 11 can alternatively be implemented with a pair of locating hole and locating plug. Another example would be a pair of interfering groove and surface rib. Furthermore, other adjoining combination can be used as well to accomplish the same function as described. For example, in FIG. 2 the control electronics module 40 can instead be adjoined to the back wall (−z-direction) of the TV housing 10 with a corresponding relocation of the second adjoining means 41 and the first adjoining means 11. Likewise, the audio module 50 can instead be adjoined to the front wall (+z-direction) of the TV housing 10, etc. As a higher positional accuracy is required, for image reflection, of the reflective mirror 12 that is also light in weight, the reflective mirror 12 can be simply bonded to the bottom surface of a slanted segment of the TV housing 10 as shown. Of course, while bearing in mind its required higher positional accuracy, the reflective mirror 12 can be detachably adjoined to the bottom surface of the slanted segment of the TV housing 10 as well.

Given the above description, it can be seen that during manufacturing each of the various subassemblies can be adjoined to its corresponding housing segments to form a set of size-wise compact intermediaries without further assembling these intermediaries into the final bulky rear projection TV 100. The set of compact intermediaries can then be shipped, as is, to the end user for self-assembly with reduced shipping volume thus simplified shipping logistics. Clearly, an additional accompanying advantage is the reduction in production assembly time and cost. Furthermore, for product maintenance, the user only needs to purchase and self-assemble the damaged intermediary or intermediaries as well.

FIG. 2A is a lateral sectional view, along section A-A of FIG. 1, of another embodiment of the present invention where a two-mirror system is employed to form a thinner TV housing 10, along the z-direction, of the adjoining-type rear projection TV 100. A first reflective mirror 17 is located behind and adjoined to a back top surface of a front portion of the TV housing 10. Additionally, a second reflective mirror 18 is located beneath and adjoined to a bottom surface of a slanted back portion of the TV housing 10. The image projection onto the projection screen 20, as illustrated, takes place via a relocated lens head 31 and the two reflective mirrors 17 and 18 signified with two source beams 31a and 31b, two corresponding reflected source beams 31c and 31d and two corresponding second-reflected source beams 31e and 31f all contained within the TV housing 10. Thus, for those skilled in the art, it should be appreciated that through a mechanism of multiple reflective folding of the video image projection light path, the resulting TV housing 10 can be made thinner than that of a single mirror system of FIG. 2. Certainly, within a reasonable limit, additional reflective mirrors can be employed to further reduce the thickness of the TV housing 10.

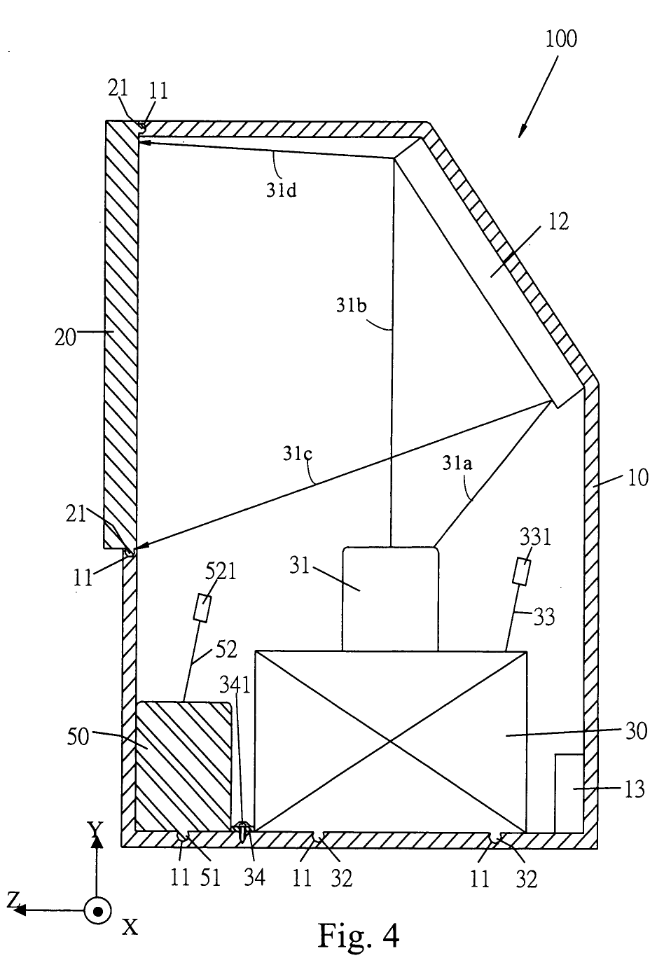

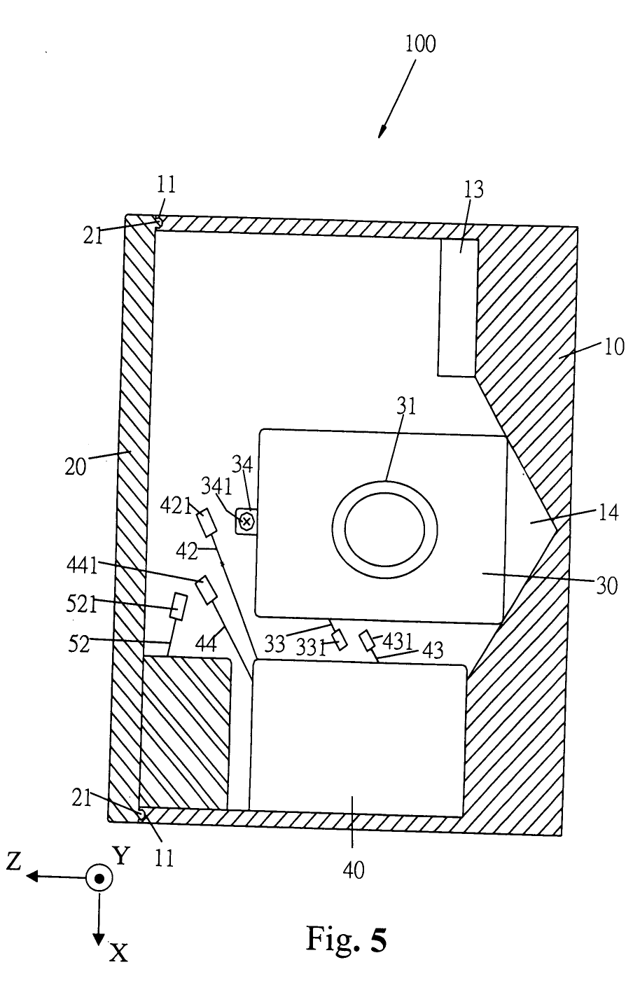

Another embodiment of the present invention rear projection TV are illustrated in FIG. 4, a lateral A-A sectional view, and FIG. 5, a top C-C sectional view, of the adjoining between some of its subassemblies and the TV housing. Another subassembly, called 10 and power terminal 13, is located inside the bottom rear corner of the TV housing 10 for the audio and video signal interfacing and power input to the adjoining-type rear projection TV 100. While the details are not shown here, the 10 and power terminal 13 can likewise be detachably adjoined to either the bottom or the rear interior of the TV housing 10. An affixing indentation 14 in the form of a V-notch is formed on an interior rear surface of the TV housing 10. The affixing indentation 14 faces and is designed for accurately locating the position of the body of the optical mechanism 30 thus effecting essentially an accurate optical alignment of the lens head 31 atop the body of the optical mechanism 30. In combination with the affixing indentation 14, a locking feature in the form of a locking tab 34 is provided towards the bottom of the body of the optical mechanism 30 that, upon being locked onto an interior bottom surface of the TV housing 10 with a locking screw 341 forces the optical mechanism body into a pre-determined, three-point contact registration with the TV housing 10. In other words, upon assembly of the various segments of the TV housing 10, the lens head 31 gets forced into essentially an optical alignment with the reflective mirror 12 and the projection screen 20 such that, during operation of the adjoining-type rear projection TV 100, projected lights of a video image emanated from the lens head 31 impinge upon the reflective mirror 12, get reflected there from thus optically coupled and projected onto the projection screen 20 for proper viewing by the user. By now it should also become clear that numerous variations of this specific embodiment for the optical alignment of the lens head 31 could work as well. For example, the surface contour of the affixing indentation 14 can alternatively be cylindrical. The locking feature can be formed as a simple extended lip along the bottom edge of the optical mechanism 30 with the locking screw 341 replaced by a locking lever pressing onto the extended lip, etc.

Yet another embodiment of the present invention rear projection TV, while not graphically illustrated here, is as follows:

Regardless of the above scheme for optically aligning the lens head 31 with the reflective mirror 12 and the projection screen 20, it nevertheless is an indirect mechanical scheme not based upon a direct image alignment at the projection screen 20. Thus, due to numerous unavoidable dimensional or optical tolerances of the parts constituting the adjoining-type rear projection TV 100, a residual optical misalignment in the form of a likely perceptible image misalignment at the projection screen 20 can still be expected from volume production. To insure user self-assembly of the adjoining-type rear projection TV 100 without any special skills or tools, the effect of this residual optical misalignment can be rendered imperceptible to the user by sizing at least one of the optical mechanism 30, the reflective mirror 12 or section(s) of the TV housing 10 for a projected video image 3% to 5% larger than the projection screen 20. Here, sizing can be a simple dimensional adjustment or a more complex optical adjustment from an otherwise nominal design. For example, adjusting the projection screen 20 slightly forward (+z-direction) from its ideal position would increase the total video image projection light path length hence enlarge the projected video image. For another example, slightly thinning the body of the reflective mirror 12 from its ideal thickness would also increase the total video image projection light path length hence enlarge the projected video image. For a third example, slightly reducing the f-number of the lens head 31 from its ideal value would maintain the total video image projection light path length while enlarging the projected video image, etc. To reduce the effect of any stray image resulting from the small amount of projected video image outside the projection screen 20, all interior surfaces of the adjoining-type rear projection TV 100 not required for the video image projection can be painted black to render these surfaces essentially non-reflective.

To make electrical connections as part of the assembly process, and disassembly process as the case may be, of the adjoining-type rear projection TV 100, the optical mechanism 30 is provided with video input lines 33 terminated with a video input terminal 331 for electrically connecting with corresponding video terminal 431 and video output lines 43 provided on the control electronics module 40. Secondly, the audio module 50 is provided with audio input lines 52 terminated with an audio terminal 521 for electrically connecting with corresponding audio terminal 441 and audio output lines 44 provided on the control electronics module 40. Thirdly, the control electronics module 40 is provided with signal and power lines 42 terminated with an input terminal 421 for electrically connecting with, while not shown here to avoid excessive obscuring details, corresponding output terminal and signal and power lines provided on the control 10 and power terminal 13. In this way, the set of aforementioned advantages of end user self-assembly, reduced shipping volume and simplified shipping logistics, etc. gets expanded to the area of electrical assembly for the adjoining-type rear projection TV 100 as well.

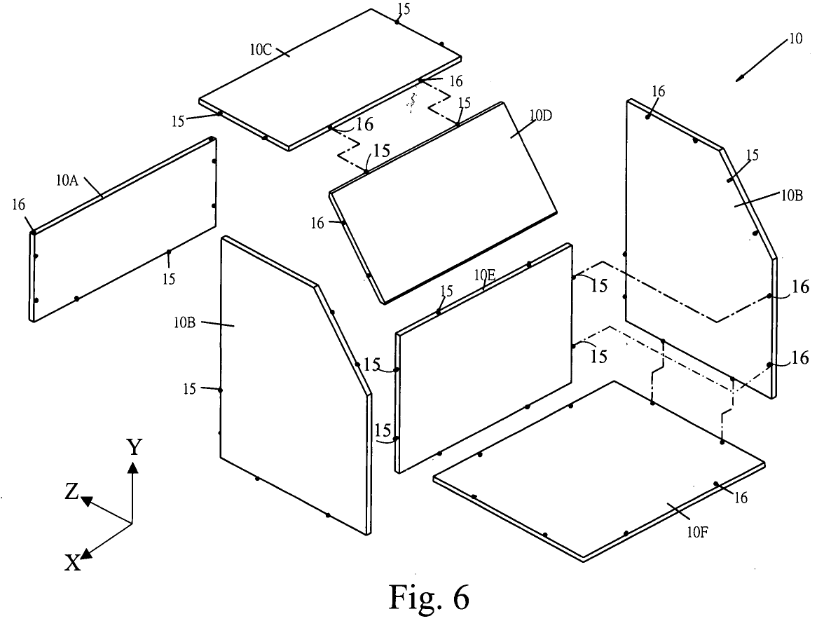

FIG. 6 is a perspective view of a third embodiment of the present invention illustrating the adjoining of interconnectable housing segments to form the TV housing 10. The set of housing segments includes a bottom housing plate 10F lying substantially in the x-z plane. Two lateral housing plates 10B, each lying substantially in the y-z plane, are located atop and connected to a corresponding edge of the bottom housing plate 10F. A back housing plate 10E, lying substantially in the x-y plane, is located atop and connected to a back edge of the bottom housing plate 10F and two back edges of the lateral housing plates 10B. A slanted back housing plate 10D is located atop and connected to a top edge of the back housing plate 10E and two correspondingly slanted edges of the lateral housing plates 10B. A top housing plate 10C, lying substantially in the x-z plane, is located atop and connected to a top edge of the slanted back housing plate 10D and two corresponding top edges of the lateral housing plates 10B. A front housing plate 10A, lying substantially in the x-y plane, is located atop and connected to a front edge of the bottom housing plate 10F and the lower portion of two front edges of the lateral housing plates 10B so as to leave a projection opening for the projection screen 20. The housing segments are adjoined, along each adjoining edge, to one another with a number of third adjoining means located on one housing segment mating with the same number of fourth adjoining means located on the other housing segment. For example, two fourth adjoining means 16, located along the back edge of the top housing plate 10C, are provided for adjoining to two third adjoining means 15 located along the top edge of the slanted back housing plate 10D. For another example, two fourth adjoining means 16, located along the back edge of each of the lateral housing plates 10B, are provided for adjoining to two third adjoining means 15 located along one side edge of the back housing plate 10E, etc. As illustrated, the specific embodiment of the fourth adjoining means 16 and the third adjoining means 15 are respectively a locating hole and a locating plug. For those skilled in the art, numerous other embodiments can replace the specifically illustrated design of locating hole and locating plug while still accomplishing the same function of detachably adjoining the various housing segments. For example, while not graphically illustrated here, the pair of fourth adjoining means 16 and third adjoining means 15 can alternatively be implemented with a pair of cavity and lo resilient protrusion. Another example would be a pair of interfering groove and surface rib.

An adjoining-type architecture for the assembly of a rear projection TV through the formation of a set of intermediaries is described with numerous exemplary embodiments. This architecture reduces the projecting TV production assembly time and cost, reduces its shipping volume thus simplifying its shipping and allowing user self-assembly. For product maintenance, this architecture further allows the user to purchase and self-assemble only the damaged subassemblies. However, for those skilled in this field, these exemplary embodiments can be easily adapted and modified to suit additional applications without departing from the spirit and scope of this invention. Thus, it is to be understood that the scope of the invention is not limited to the disclosed embodiments. On the contrary, it is intended to cover various modifications and similar arrangements based upon the same operating principle. The scope of the claims, therefore, should be accorded the broadest interpretations so as to encompass all such modifications and similar arrangements.

1. An adjoining-type architecture for the assembly of a rear projection TV comprising:
(a) a set of interconnected housing sections HS₁, HS₂, . . . , HSᵢ, . . . , HS_{M} forming the enclosure of the rear projection TV;
(b) a set of interconnected subassemblies SA₁, SA₂, . . . , SAⱼ, . . . , SA_{N} providing the projecting TV function wherein at least one of the subassembly SAⱼ further comprises a number of second adjoining means for adjoining said SAⱼ to a selected subset of said housing sections; and
(c) each housing section HSᵢ further comprises a number of first adjoining means for adjoining said HSᵢ to a corresponding subset of said second adjoining means of said at least one of the set of interconnected subassemblies to form a set of intermediaries inside the enclosure without further assembling these intermediaries into the rear projection TV

2. The adjoining-type architecture of claim 1 wherein at least one of said second adjoining means allows for detachable adjoining said SAⱼ to a selected subset of said housing sections.

3. The adjoining-type architecture of claim 1 wherein at least one of said first adjoining means allows for detachable adjoining said HSᵢ to a corresponding subset of said second adjoining means of said at least one of the set of interconnected subassemblies.

4. The adjoining-type architecture of claim 1 wherein the interconnection between any two housing sections HSᵢ₁ and HSᵢ₂, where 1<=i1<=M and 1<=i2<=M, is effected with a number of third adjoining means located on said housing section HSᵢ₁ mating with the same number of fourth adjoining means located on said housing section HSᵢ₂.

5. The adjoining-type architecture of claim 1 wherein the interconnection among said set of subassemblies SA₁, SA₂, . . . , SAⱼ, . . . , SA_{N} is through a mechanical connection, an electrical connection or an optical coupling.

6. The adjoining-type architecture of claim 1 wherein, expressed with x-y-z Cartesian coordinates with the y-axis pointing to the top and the z-axis pointing to the front, said set of housing sections further comprises a bottom housing plate lying substantially in the x-z plane, two lateral housing plates each lying substantially in the y-z plane, located atop and connected to a corresponding edge of the bottom housing plate, a back housing plate lying substantially in the x-y plane, located atop and connected to a back edge of the bottom housing plate and two back edges of the lateral housing plates, a slanted back housing plate lying in a slanted plane tilted away from the x-y plane toward the z-direction, located atop and connected to a top edge of the back housing plate and two correspondingly slanted edges of the lateral housing plates, a top housing plate lying substantially in the x-z plane, located atop and connected to a top edge of the slanted back housing plate and two corresponding top edges of the lateral housing plates and a front housing plate lying substantially in the x-y plane, located atop and connected to a front edge of the bottom housing plate and the lower portion of two front edges of the lateral housing plates so as to define a projection opening lying substantially in the x-y plane and along the front face of the projecting TV.

7. The adjoining-type architecture of claim 6 wherein said set of subassemblies further comprises a control electronics module, an optical mechanism and an audio module all located atop and detachably adjoining to said bottom housing plate, a projection screen lying substantially in the x-y plane and substantially filling the projection opening by detachably adjoining to a top edge of the front housing plate, the upper portion of two front edges of the lateral housing plates and a front edge of the top housing plate.

8. The adjoining-type architecture of claim 7 further comprises at least one reflective mirror located within said enclosure of the rear projection TV for reflecting projected lights of a video image emanated from the optical mechanism so as to form projected images on the projection screen for proper viewing by the user.

9. The adjoining-type architecture of claim 7 wherein said at least one reflective mirror further comprises a first reflective mirror located behind and adjoining to a back top surface of said front housing plate and a second reflective mirror located beneath and adjoining to a bottom surface of said slanted back housing plate whereby, through a mechanism of multiple folding of the video image projection light path, forming a thinner enclosure of the rear projection TV along the z-direction.

10. The adjoining-type architecture of claim 7 wherein said set of subassemblies further comprises an IO and power terminal, for the audio and video signal interfacing and power input to the projecting TV, located atop and detachably adjoining to said bottom housing plate.

11. The adjoining-type architecture of claim 10 wherein said optical mechanism further comprises a body having a lens head on top that is essentially optically aligned with said reflective mirror and said projection screen such that projected lights of a video image emanated from the lens head impinge upon the reflective mirror, get reflected there from thus coupled and projected to the projection screen for proper viewing by the user.

12. The adjoining-type architecture of claim 11 wherein the essential optical alignment further comprises sizing at least one of said set of housing sections, said optical mechanism and said reflective mirror to make the projected video image slightly larger than the projection screen thereby rendering the effect of residual optical misalignment imperceptible to the user.

13. The adjoining-type architecture of claim 12 wherein the projected video image is larger than the projection screen by an amount in the range of from about 3% to about 5%.

14. The adjoining-type architecture of claim 12 wherein the interior surfaces of the rear projection TV, which are not required for the video image projection, essentially non-reflective thereby further reducing the effect of any stray image resulting from the projected video image outside the projection screen.

15. The adjoining-type architecture of claim 14 wherein said non-reflective interior surfaces are painted with black.

16. The adjoining-type architecture of claim 11 wherein the essential optical alignment of said lens head is effected through the alignment of the body of the optical mechanism.

17. The adjoining-type architecture of claim 16 wherein the essential optical alignment of the body of the optical mechanism is by way of aligning it against part of said set of housing sections.

18. The adjoining-type architecture of claim 17 wherein aligning the optical mechanism body against part of said set of housing sections is effected through the combination of an affixing indentation formed on an interior surface of the back housing plate and a locking feature that, being part of the optical mechanism body, upon being locked onto an interior surface of the bottom housing plate with a locking means forces the optical mechanism body into a pre-determined, three-point contact registration with the enclosure of the rear projection TV.

19. The adjoining-type architecture of claim 18 wherein said locking feature is a locking tab located towards the bottom of the optical mechanism body.

20. The adjoining-type architecture of claim 10 wherein each of the control electronics module and the optical mechanism further comprises video signal lines and a video signal terminal for a connection therebetween, each of the control electronics module and the audio module further comprises audio signal lines and an audio signal terminal for a connection therebetween and each of the control electronics module and the IO and power terminal further comprises signal and power lines and a signal and power lines terminal for a connection therebetween.

21. A rear projection TV having an adjoining-type architecture, comprising:
(a) a set of interconnected housing sections forming the enclosure of the rear projection TV;
(b) a set of interconnected subassemblies comprising a control electronics module, an optical mechanism, an audio module, and a projection screen to provide the projecting TV function wherein at least one of the subassembly further comprises a number of second adjoining means for adjoining said subassembly to a selected subset of said housing sections; and
(c) each housing section further comprises a number of first adjoining means for adjoining said housing section to a corresponding subset of said second adjoining means of said at least one of the set of interconnected subassemblies to form a set of intermediaries within said enclosure of the rear projection TV.

22. The rear projection TV of claim 21 wherein at least one of said second adjoining means allows for detachable adjoining said subassembly to a selected subset of said housing sections.

23. The rear projection TV of claim 21 wherein at least one of said first adjoining means allows for detachable adjoining said housing section to a corresponding subset of said second adjoining means of said at least one of the set of interconnected subassemblies.

24. The rear projection TV of claim 21 wherein the interconnection between any two housing sections is effected with a number of third adjoining means located on said first housing section mating with the same number of fourth adjoining means located on said second housing section.

25. The rear projection TV of claim 21 wherein the interconnection among said set of subassemblies is through a mechanical connection, an electrical connection or an optical coupling.

26. The rear projection TV of claim 21 wherein, expressed with x-y-z Cartesian coordinates with the y-axis pointing to the top and the z-axis pointing to the front, said set of housing sections further comprises a bottom housing plate lying substantially in the x-z plane, two lateral housing plates each lying substantially in the y-z plane, located atop and connected to a corresponding edge of the bottom housing plate, a back housing plate lying substantially in the x-y plane, located atop and connected to a back edge of the bottom housing plate and two back edges of the lateral housing plates, a slanted back housing plate lying in a slanted plane tilted away from the x-y plane toward the z-direction, located atop and connected to a top edge of the back housing plate and two correspondingly slanted edges of the lateral housing plates, a top housing plate lying substantially in the x-z plane, located atop and connected to a top edge of the slanted back housing plate and two corresponding top edges of the lateral housing plates and a front housing plate lying substantially in the x-y plane, located atop and connected to a front edge of the bottom housing plate and the lower portion of two front edges of the lateral housing plates so as to define a projection opening lying substantially in the x-y plane and along the front face of the projecting TV.

27. The rear projection TV of claim 26 wherein said control electronics module, said optical mechanism and said audio module all located atop and detachably adjoining to said bottom housing plate, said projection screen lying substantially in the x-y plane and substantially filling the projection opening by detachably adjoining to a top edge of the front housing plate, the upper portion of two front edges of the lateral housing plates and a front edge of the top housing plate.

28. The rear projection TV of claim 27 further comprises at least one reflective mirror wherein said reflective mirror reflects projected lights of a video image emanated from said optical mechanism so as to form projected images on said projection screen for proper viewing by the user.

29. The rear projection TV of claim 28 wherein said at least one reflective mirror further comprises a first reflective mirror located behind and adjoining to a back top surface of said front housing plate and a second reflective mirror located beneath and adjoining to a bottom surface of said slanted back housing plate whereby, through a mechanism of multiple folding of the video image projection light path, forming a thinner enclosure of the rear projection TV along the z-direction.

30. The rear projection TV of claim 27 wherein said set of subassemblies further comprises an IO and power terminal, for the audio and video signal interfacing and power input to the projecting TV, located atop and detachably adjoining to said bottom housing plate.

31. The rear projection TV of claim 30 wherein said optical mechanism further comprises a body having a lens head on top that is essentially optically aligned with said reflective mirror and said projection screen such that projected lights of a video image emanated from the lens head impinge upon the reflective mirror, get reflected therefrom thus coupled and projected to the projection screen for proper viewing by the user.

32. The rear projection TV of claim 31 wherein the optical alignment further comprises sizing at least one of said set of housing sections, said optical mechanism and said reflective mirror to make the projected video image slightly larger than the projection screen thereby rendering the effect of residual optical misalignment imperceptible to the user.

33. The rear projection TV of claim 32 wherein the projected video image is larger than the projection screen by an amount in the range of from about 3% to about 5%.

34. The rear projection TV of claim 32 wherein all interior surfaces of the rear projection TV, which are not required for the video image projection, are essentially non-reflective thereby further reducing the effect of any stray image resulting from the projected video image outside the projection screen.

35. The rear projection TV of claim 34 wherein said non-reflective interior surfaces are painted with black.

36. The rear projection TV of claim 31 wherein said optical alignment of said lens head is effected through the alignment of the body of the optical mechanism.

37. The rear projection TV of claim 36 wherein said optical alignment of the body of the optical mechanism is by way of aligning it against part of said set of housing sections.

38. The rear projection TV of claim 37 wherein aligning the optical mechanism body against part of said set of housing sections is effected through the combination of an affixing indentation formed on an interior surface of the back housing plate and a locking feature that, being part of the optical mechanism body, upon being locked onto an interior surface of the bottom housing plate with a locking means forces the optical mechanism body into a predetermined, three-point contact registration with the enclosure of the rear projection TV.

39. The rear projection TV of claim 38 wherein said locking feature is a locking tab located towards the bottom of the optical mechanism body.

40. The rear projection TV of claim 30 wherein each of the control electronics module and the optical mechanism further comprises video signal lines and a video signal terminal for a connection therebetween, and each of the control electronics module and the IO and power terminal further comprises signal and power lines and a signal and power lines terminal for a connection therebetween.

41. A method of partitioning the architecture of a rear projection TV for easy assembling and disassembling, comprising:
(a) partitioning the enclosure of the rear projection TV into a set of interconnectable housing sections HS₁, HS₂, . . . , HSᵢ, . . . , HS_{M};
(b) partitioning the internal components of the projecting TV into a set of interconnectable subassemblies SA₁, SA₂, . . . , SAⱼ, . . . , SA_{N} and providing at least one of the subassembly SAⱼ with a number of second adjoining means for adjoining said SAⱼ to a selected subset of said housing sections; and
(c) providing each housing section HSᵢ with a number of first adjoining means and adjoining said HSᵢ to a corresponding subset of said second adjoining means of said at least one of the set of interconnectable subassemblies thus forming a set of intermediaries within the enclosure.

42. The method of claim 41 wherein assembling said set of interconnectable housing sections, for interconnecting any two housing sections HSᵢ₁ and HSᵢ₂, where 1<=i1<=M and 1<=i2<=M, further comprises providing said housing section HSᵢ₁ with a number of third adjoining means, providing said housing section HSᵢ₂ with the same number of fourth adjoining means and mating the third adjoining means with the fourth adjoining means.

43. The method of claim 41 wherein interconnecting said set of subassemblies SA₁, SA₂, . . . , SAⱼ, . . . , SA_{N} further comprises mechanically connecting, electrically connecting or optically coupling them.
